(19) United States
(12) Patent Application Publication
(10) Pub. No.: US 2014/0281730 A1
(43) Pub. Date: Sep. 18, 2014

(54) DEBUGGING SESSION HANDOVER

(71) Applicant: CADENCE DESIGN SYSTEMS, INC., San Jose, CA (US)

(72) Inventors: Nadav CHAZAN, Ness Ziona (IL); Ynon Cohen, Kfar Saba (IL); Yonatan Ashkenazi, Rehovot (IL); Nir Paz, Moshav Gealia (IL); Tal Tabakman, Tel Aviv (IL)

(73) Assignee: Cadence Design Systems, Inc., San Jose, CA (US)

(21) Appl. No.: 13/803,955

(22) Filed: Mar. 14, 2013

(51) Int. Cl. G06F 11/36

(52) U.S. Cl. CPC G06F 11/362
USPC 714/38.1

(57) ABSTRACT

A method includes, during operation of a software debugging tool on a software program, and upon indication by a first user of the software debugging tool of a step of the operation as a event of interest, collecting data related to that event of interest. A unique identifier is assigned to the collected data. Access to the collected data is enabled for a second user of the software debugging tool.

### FIELD OF THE DISCLOSURE

The present disclosure relates to debugging tools and particularly to handing over a debugging session from one user to another.

### BACKGROUND

As computer programming and hardware design becomes more complex, the size of a typical team involved with different aspects of development and testing grows ever larger. Often a person who starts debugging after a detected failure is not able to complete the debugging process alone and needs the help of colleagues. The different people taking part in the debugging process may be geographically separated from one another.

Debugging tools have been developed for assisting a developer in locating problems with a software program or with hardware design. Debugging tools typically enable a developer or another user to examine the status, environment, or results of execution of the program at selected steps or points of execution.

Post-process debugging tools record information regarding the execution of a program throughout the run of the program under the debugging tool. Using this recorded information, a post-process debugging tool enables examination of any point during the execution. (A debugging tool without post-process capability only enables examination of a current scope of a current code segment being executed.)

### SUMMARY

There is thus provided, in accordance with some embodiments, a method comprising: during operation of a software debugging tool with post-process capability on a software program, and upon indication by a first user of the software debugging tool of a step of the operation as an event of interest, collecting data related to that event of interest; assigning a unique identifier to the collected data; and enabling access to the collected data by a second user of the software debugging tool.

Furthermore, in accordance with some embodiments, collecting the data includes enabling entering of an annotation.

Furthermore, in accordance with some embodiments, the collected data includes a configuration of displayed execution data.

Furthermore, in accordance with some embodiments, enabling access includes storing the collected data and the unique identifier in a database that is accessible by the second user.

Furthermore, in accordance with some embodiments, the database is accessible to the first user and to the second user via a network.

Furthermore, in accordance with some embodiments, enabling access includes sending a notification to the second user.

Furthermore, in accordance with some embodiments, the method further includes enabling the second user to operate the software debugging tool to utilize the identifier of each of a plurality of the events of interest that were indicated by the first user to navigate to a selected event of interest of the plurality of events of interest.

Furthermore, in accordance with some embodiments, navigating to the selected event of interest includes reproducing a configuration of a display by the software debugging tool.

Furthermore, in accordance with some embodiments, navigating to the selected event of interest includes enabling access to an annotation related to the selected event of interest.

There is further provided, in accordance with some embodiments, a non-transitory computer readable storage medium having stored thereon instructions that when executed by a processor will cause the processor to perform the method of: enabling indication of an event of interest during operation of a software debugging tool with post-process capability; collecting data related to the indicated event of interest; assigning a unique identifier to the collected data; and enabling access to the collected data.

Furthermore, in accordance with some embodiments, the stored instructions include instructions to enable entering of an annotation related to the indicated event of interest.

Furthermore, in accordance with some embodiments, the stored instructions include instructions to generate a notification regarding the identified event of interest.

Furthermore, in accordance with some embodiments, the stored instructions include instructions to store the collected data with the unique identifier.

Furthermore, in accordance with some embodiments, the stored instructions include instructions to enable selection of an event of interest from a plurality of the indicated events of interest.

Furthermore, in accordance with some embodiments, the stored instructions include instructions to reproducing a configuration of a display by the software debugging tool at the time of indication of the selected event of interest.

Furthermore, in accordance with some embodiments, the stored instructions include instructions to enable access to an annotation related to the selected event of interest.

Furthermore, in accordance with some embodiments, the stored instructions include instructions to enable continued operation of the software debugging tool after the selection of an event of interest.

There is further provided, in accordance with some embodiments, a system including: a processing unit in communication with a computer readable medium, wherein the computer readable medium contains a set of instructions wherein the processing unit is designed to carry out the set of instructions to: enable indication of one or more events of interest during operation of a software debugging tool with post-process capability; collect data related to each of the events of interest; assign a unique identifier to the collected data related to each of the events of interest; enable access to the collected data; and enable selection of an event of interest of the events of interest.

Furthermore, in accordance with some embodiments, the system includes a plurality of intercommunicating workstations.

Furthermore, in accordance with some embodiments, the selection of the event of interest is enabled at a workstation that is different than a workstation that is operated to indicate the events of interest.

### BRIEF DESCRIPTION OF THE DRAWINGS

In order to better understand the present disclosure, and appreciate its practical applications, the following Figures are provided and referenced hereafter. It should be noted that the Figures are given as examples only and in no way limit the scope of the disclosure. Like components are denoted by like reference numerals.

FIG. 1 is a schematic illustration of a system for implementation of debugging session handover, in accordance with an embodiment.

FIG. 2 is a flowchart depicting a method for debugging session handover, in accordance with an embodiment.

FIG. 3 is a flowchart depicting a method for enabling examination of data after debugging session handover, in accordance with an embodiment.

### DETAILED DESCRIPTION OF EMBODIMENTS

In the following detailed description, numerous specific details are set forth in order to provide a thorough understanding of the disclosure. However, it will be understood by those of ordinary skill in the art that embodiments may be practiced without these specific details. In other instances, well-known methods, procedures, components, modules, units and/or circuits have not been described in detail so as not to obscure embodiments.

In accordance with embodiments, a software debugging tool is provided with a capability for enabling a debugging session to be handed over from one user to another. Debugging session handover as used herein refers to storing information by a user during a debugging session (referring herein to operation of the software debugging tool on a software program) in such a manner that another user who retrieves the information may continue the debugging session. For example, the user that continues the debugging session may retrieve information regarding findings by the previous user.

The software debugging tool is operable to enable a user to examine various results of execution of a software program during various stages or steps of the execution. The software debugging tool is configured to enable a first user who is operating the software debugging tool to indicate one or more events of interest during a debugging session on a software program. Information with regard to the indicated events of interest may be stored and uniquely labeled in an appropriate format for later retrieval in association with the software program being debugged. A second user may operate the software debugging tool to continue debugging of the same software program that was being debugged by the first user. The software debugging tool is configured to enable the second user to retrieve that stored information regarding the indicated labeled points, and to utilize the retrieved information in operating the software debugging tool. For example, the software debugging tool is configured to enable the second user to reproduce a state or step of execution of the software program that was of interest to the first user.

As used herein, debugging refers to any analysis of execution of a software program whether or not the purpose of the analysis is to detect faulty operation (bug) of the software program. A software debugging tool refers to a software program or application, or to a collection or suite of such software programs or applications, that assists a user (e.g., a software developer, verification engineer, or hardware designer) in performing such debugging. For example, a software debugging tool may enable viewing various execution results during execution of the software program being debugged. As used herein, an execution result may include, for example, a current value of a variable (e.g., including an indication of whether the variable is currently within scope), a status of a computing environment (e.g., an error or warning message or a location of a breakpoint), an indication (e.g., text, line, or location within a source code representation or other representation of the software program being debugged, a function currently being executed, an instruction that called the function being currently executed, or other indication) of an instruction that is being executed or that was most recently executed, an address of a variable or instruction, or other relevant information that may be displayed or otherwise made available to a user of the software debugging tool.

A software program being debugged may be intended for execution by a processor, such as of a computer or other device with a capability for data processing, or may be intended for incorporation in the design of an integrated circuit. As used herein, a software program is to be understood as including a description of an electronic circuit (e.g., an integrated circuit), such as a hardware description language (HDL) representation of an electronic circuit.

A software debugging tool may enable stopping execution of the software program being debugged at predetermined points of execution of the program (breakpoints) or under predefined conditions or circumstance (break conditions). The software debugging tool may enable stepped execution of the software program being debugged and examination of execution results at each step.

The software debugging tool may enable post-process examination of results of previously executed steps of the software program being debugged. As used herein, post-process capability refers to a capability to examine execution results after a recording phase has ended or has been paused. During the recording phase, all the information that was collected regarding the execution of the software program being debugged was processed and stored by the software debugging tool. After the recording phase, the collected information is available and can help debug any previous point of time in the run of the program. The term does not necessarily imply that the process of debugging the program being debugged has terminated.

For example, the software debugging tool may automatically store execution results at each step of execution of the software program being debugged. As another example, the software debugging tool may enable storing of execution results at each step between points that are selected by a user of the software debugging tool. For example, the selected points may include a breakpoint or another specific time, step, or point during execution.

Reference herein to first and second users may refer to different users at geographically separated locations, to different users (e.g., collaborators) at a single geographic location, or to a single user at different times (or operating different instances of the software debugging tool on one or more different computers). The first and second users may be operating the software debugging tool at different times, or may operate the software debugging tool concurrently (e.g., at different locations or on different computers). The first and second users may access a common computer, processor, storage device, storage facility, or other device, service, or facility to enable collaborative debugging of a single software program, or may be in communication with one another, e.g., via a network. For example, the users may attain common access using different devices (e.g., mobile phones or computers, stationary computers or terminals, using a network or network-based service).

Reference herein to the users of the software debugging tool as first and second users is for convenience only, and should not be understood as limiting operation to two users. There may be more than two users. For example, a second user may retrieve information with regard to points of execution that were identified by the first user. The second user may identify additional points in the execution, or modify information with regard to points that were identified by the first user. The additional or modified information may then be stored by the second user, and may be retrieved by a subsequent user (who may be identical to the first user or to the second user, or may be another user). Thus, a single user may function as the second user with regard to a previous user, and as the first user with regard to a subsequent user.

As used herein, a computer may refer to any computing device, system, or service that includes a processor or processing capability that is operable in accordance with programmed instructions. For example, a computer as referred to herein may include a stationary computer, a mobile computer, a server-based computer system, a network-based service (“cloud computing”), or any other programmable computing or processing device, system, or service.

Stored information with regard to each indicated event of interest may be stored as a record in a database, as a data file, as a data structure within a file, or in any other manner that enables storing and retrieval of information that is associated with a single identified event of interest. Any such system or method of retrievably storing data is referred to herein as a database. Information or data regarding the identified event of interest includes a unique identifier. The identifier may include a label (e.g., in the form of a sequentially assigned label or number), a number (e.g., indicating a position in a series of sequentially identified events of interest), an index, or an address. The identifier enables retrieving the information by the second user. The identifier may be utilized in retrieval of information with regard to a particular identified event of interest. For example, the identifier may be utilized as an index of an indexed database, or may be utilized in sorting or ordering the identified events of interest to enable convenient retrieval by the second user.

The stored information regarding an identified event of interest may include configuration information for configuring displayed execution results. For example, the first user, when causing information regarding an identified event of interest to be stored, may have configured a display screen of the software debugging tool in a particular manner (e.g., displaying selected execution results while hiding others). For example, the first user may have selected one tab of several optional screen tabs in order to display a particular set of execution results, may have selected to display particular rows or columns of a table or may have selected one of the rows or columns, may have selected or highlighted a particular displayed content, may have applied a sorting or filtering rule, or any other user-selected display configuration. Information regarding that screen configuration may be stored as part of the information for that identified event of interest.

The stored information may include one or more annotations or comments that were entered by the first user in association with the indicated event of interest. For example, the first user may enter a comment in text form. As another example, the first user may otherwise mark or indicate an execution result that the first user considers to be important, relevant, or of interest to the second user.

In accordance with some embodiments, the stored information may include execution parameters (e.g., input data or startup parameters) for enabling reproduction of the debugging session. Alternatively, or in addition, the stored information may include all or some of the execution results at the identified event of interest.

When the software debugging tool is used by the second user, the second user may retrieve the stored information regarding the identified events of interest. The software debugging tool includes a capability to navigate to one of the identified events of interest and displaying the stored information regarding that point (in addition to any information that is generated by operation of the software debugging tool). For example, the software debugging tool may retrieve configuration information. The retrieved configuration information may be utilized to reproduce a displayed screen configuration that was displayed when the first user caused the information to be stored. In addition, any annotations or other marking of displayed information may be retrieved and displayed. Thus, the attention of the second user may be directed to those execution results that the first user indicated as being of particular interest.

FIG. 1 is a schematic illustration of a system for implementation of debugging session handover, in accordance with an embodiment.

Debugging system 10 includes one or more intercommunicating workstations. The workstations include a first workstation 12, operated by a first user, and a second workstation 14, operated by a second user. First workstation 12 and second workstation 14 may represent two different computers or machines, may represent a single machine being used by two different users, or may represent a single machine and user at different times. First workstation 12 and second workstation 14 may represent stationary or mobile computers that include processing capability. First workstation 12 and second workstation 14 may represent terminals that enable communication between first workstation 12 and second workstation 14 and a remote processor, and in which some or all processing capability is located at a remote location.

Each of first workstation 12 and second workstation 14 includes input capability. Thus, a user operating first workstation 12 or second workstation 14 may input (e.g., via a keyboard, keypad, touch screen, pointing device, or other input device) instructions or data related to operation of a software debugging tool. Each of first workstation 12 and second workstation 14 includes output capability. Thus, a user operating first workstation 12 or second workstation 14 may receive (e.g., via a display screen or other output device) results (e.g., execution results) of operation of a software debugging tool.

Each of first workstation 12 and second workstation 14 is capable of communicating via communication 16 with one another, with processor 20, and with data storage 18. Communication 16 may represent a wired or wireless network connection (e.g., when first workstation 12 and second workstation 14 represent physically separate computers or terminals). Communication 16 may represent internal communication channels, connections, or busses (e.g., when first workstation 12 and second workstation 14 represent a single computer used at different times).

Processor 20 may represent one or more processing units that are capable of operating in accordance with programmed instructions. For example, processor 20 may be operated to execute software program 22 or software debugging tool 24. Software debugging tool 24 may be executed to assist in debugging software program 22.

One or more components of processor 20 may be incorporated into first workstation 12, second workstation 14, or both. One or more components of processor 20 may be incorporated into a processing unit that is remote to both first workstation 12 and second workstation 14, and is accessible to both first workstation 12 and to second workstation 14 (as schematically shown in FIG. 1, for convenience of the presentation). For example, one or more components of processor 20 may be incorporated into a server or network-based computing system.

Data storage 18 may represent one or more fixed or removable, volatile or non-volatile, data storage or memory units. For example, data storage 18 may include a data storage unit or memory unit that is incorporated into, or is accessible by, first workstation 12, second workstation 14, or both. For example, data storage 18 may represent a shared region of a data storage unit of first workstation 12 or of second workstation 14. Data storage 18 may include a component that is remote to both first workstation 12 and to second workstation 14 (as schematically shown in FIG. 1, for convenience of the presentation). For example, one or more components of data storage 18 may be incorporated into a server or network-based computing system. Data storage 18 may be remote to processor 20, or may be incorporated together with processor 20 in a single unit (e.g., computer).

Data storage 18 may be utilized to store programmed instructions for operation of processor 20. For example, data storage 18 may be utilized to store software debugging tool module 30, with instructions for execution of software debugging tool 24 on processor 20. Data storage 18 may be utilized to store data or parameters for use by processor 20 during operation, or results of operation of processor 20.

Data storage 18 may be utilized to store event-of-interest database 25. Event-of-interest database 25 may store information about events of interest in the form of records 26. For example, event-of-interest database 25 may include an indexed database, a region of data storage 18, a file, or another suitable organized collection of data regarding identified events of interest. Each record 26 may represent a record of an indexed database, a data file, a data structure, or other organized collection of data relating to a single identified event of interest. Each record 26 includes an identifier 28. For example, an identifier 28 may include a unique identifying label, index, or other data component that may be utilized in distinguishing one record 26 from another. Each record 26 includes additional information regarding an associated identified event of interest. Such additional information may include, for example, user-generated annotations, a user-determined configuration of a display or user interface associated with software debugging tool 24, or other relevant information.

For example, data storage 18 may include a computer readable medium for storing program instructions for operation of processor 20. The programmed instructions may include software debugging tool module 30. It is noted that data storage 18 may be remote from processor 20. In such cases data storage 18 may be a storage device of a remote server storing software debugging tool module 30 in the form of an installation package or packages that can be downloaded and installed for execution by processor 20.

First workstation 12 or second workstation 14 may be operated to control execution of software debugging tool 24 on processor 20. A user of first workstation 12 may indicate one or more events of interest during operation of software debugging tool on software program 22 being debugged. Each indicated event of interest and associated data may be accessed by a second user of second workstation 14.

FIG. 2 is a flowchart depicting a method for debugging session handover, in accordance with an embodiment.

Debugging session handover method 100 may be executed by a processor of a system that is configured for debugging session handover.

It should be understood with respect to flowcharts referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of the flowcharts referenced herein has been selected for convenience and clarity only. Operations of the illustrated method may be executed in an alternative order, or concurrently, with equivalent results. Such reordering of operations of the illustrated method should be understood as representing other embodiments of the illustrated method.

In accordance with an embodiment, a computer program application stored in a computer-readable medium (e.g., register memory, processor cache, RAM, ROM, hard drive, flash memory, CD ROM, magnetic media, etc.) may include code or executable instructions that when executed may instruct or cause a controller or processor to perform methods discussed herein, such as debugging session handover method 100. The computer-readable medium may be a non-transitory computer-readable media including all forms and types of computer-readable media except for a transitory, propagating signal.

Debugging session handover method 100 may be executed when a software debugging tool is operating to assist in debugging a software program (block 110). For example, the software debugging tool may include a capability or functionality to execute debugging session handover method 100.

For example, the software debugging tool may be tracing execution of a segment of the software program. As the software program is being executed, the software debugging tool may enable a user (hereinafter referred to as the first user) access to an execution result. The first user may control operation of the software debugging tool so as to configure access to the execution results. For example, the first user may select which information is displayed. Such information may include, for example, an indication of a location of the segment of the software program whose execution generated the execution results that are being currently displayed. The information may include, for example, current values or status of variables, notifications regarding execution of the software program being debugged, error notifications, analysis of effects of execution, among other relevant information. The first user may configure displayed information to determine which set of information or execution results is displayed concurrently.

In accordance with some embodiments, the software debugging tool is provided with a post-process capability. The post-process capability enables access to execution results that were generated by previous execution of a segment of the software program being debugged. Alternatively, the software debugging tool may be configured to only display results of execution of the segment of the software program being debugged that was most recently executed by operation of the software debugging tool.

An indication of an event of interest may be obtained during operation of the software debugging tool (block 120). For example, the indication may be generated by a first user operating a control (e.g., a screen control) to indicate a current point or step during the course of operation of the software debugging tool, or during execution of the software program being debugged by the software debugging tool, as an event of interest. Operation of the control by the first user may thus generate a signal or otherwise indicate that an event of interest has been selected. The generated signal or indication may be received by a processor that is executing debugging session handover method 100.

Data is collected with regard to the indicated event of interest (block 130). The collected data may include a current configuration of a display of the software debugging tool.

The collected data may include annotations or comments that are entered by a first user of the software debugging tool. For example, upon indication of an event of interest, the software debugging tool may display a user interface that enables the first user to enter annotations or comments. The user interface may include, for example, one or more displayed boxes or windows in which the first user may enter free text. Each displayed box or window may be associated with a particular feature or section of the current display, or with a particular class or item of displayed information (e.g., an execution result). Text may be entered in all or some of the displayed boxes or windows. As another example, the first user may manipulate a control, such as a navigation control, pointing device, or touch screen, to indicate a displayed screen object or item for which an annotation is to be entered. An appropriate window or box may be opened to enable the first user to enter text or another annotation regarding the selected screen object or item.

In accordance with some embodiments, the collected data may include one or more execution results. For example, if the software debugging tool is not provided with a post-process capability, the collected data may include execution results that were generated from a previously designated starting point (e.g., a previously indicated event of interest, a breakpoint of the software program being debugged, or another designated step or point). Similarly, indication of event of interest may initiate collection of execution results during subsequently executed steps of the software program being debugged. The collection of execution results may continue to a predetermined ending point (e.g., a predetermined number of steps, a predetermined change in level in a call stack, up to a previously designated ending point, or otherwise determined ending point).

The collected data with respect to the indicated event of interest is assigned a unique identifier (block 140). The unique identifier is configured to distinguish the current indicated event of interest from any previously or subsequently identified events of interest. For example, as each event of interest is indicated, a counter may be incremented. The value of the counter may be incorporated into the identifier. As another example, the identifier may incorporate a time of execution or indication, or a unique reference to a unique combination of conditions when the event of interest was indicated.

The collected data with its unique identifier is made available to another user (block 150). For example, the other user may include a user different from the first user who is operating the software debugging tool to debug the same software program as the first user concurrently with, or subsequently to, the first user. The other user may represent the first user who indicated the events of interest and who is returning to operate the software debugging tool on the software program being debugged after a break.

The collected data may be stored or otherwise made available such that the collected data may be retrieved by another user. The collected data may be stored on a data storage device that is accessible to both the first user and the other user (e.g., in a shared data storage partition, directory or folder; on a remote data storage device or server accessible via a network). A pointer or reference to the stored collected data may be sent (e.g., via a network or shared workspace) to the other user (e.g., as a notification or as incorporated into an email letter). As another example, the collected data may be sent (e.g., via a network) by the first user (or automatically or by a system administrator) to the other user (e.g., as part of a notification or as an attachment to an email).

For example, the collected data may be stored as a record in a database, with its unique identifier being utilized as an index for retrieval of a desired set of collected data. The collected data may be stored as a data structure within a memory or data storage device. The collected data may be stored as a file on a data storage device (e.g., with the unique identifier incorporated into a name of the file to enable identification of the file that is associated with a given identified event of interest).

In accordance with an embodiment, the collected data may be made available to another user when indicated by the first user.

For example, execution of debugging session handover method 100 may be repeated for a plurality of indicated events of interest. The collected data for each indicated event of interest may be made available immediately to the other user. For example, the other user may monitor actions of the first user from a remote location (e.g., on a remote display screen).

As another example, the operations represented by blocks 110 through 140 of debugging session handover method 100 may be repeated for a plurality of indicated events of interest. When the first user has completed indicating events of interest, the data may then be stored, sent to the other user, or otherwise made available to the other user (the operation represented by block 150 of debugging session handover method 100). At this point a notification or invitation to examine the collected data may be issued or sent to the other user.

The software debugging tool may be configured to enable the other user, hereinafter referred to as the second user, to navigate to the identified events of interest and examine the corresponding collected data and execution results.

FIG. 3 is a flowchart depicting a method for enabling examination of data after debugging session handover, in accordance with an embodiment.

Event of interest examination method 200 may be executed by a processor of a system that is configured for debugging session handover.

Event of interest examination method 200 may be executed when a software debugging tool is operating to assist in debugging a software program (block 210). For example, the software debugging tool may include a capability or functionality to execute event of interest examination method 200.

An event of interest to examine may be selected (block 220). For example, the second user may have been granted access to collected data regarding one or more events of interest that were selected by the first user. For example, a notification may be received that indicates to the second user that data collected in connection with one or more event of interest is available.

The software debugging tool may be provided with screen controls, or may be configured to interact with operation of other controls, that enable navigation by the second user directly to a selected event of interest. In this manner, the second user may view data associated with the selected event of interest without having to examine (or cause execution of, when the software debugging tool is not provided with post-process capability) preceding or intermediate steps in execution of the software program being debugged. For example, if the software debugging tool has a post process capability (or a limited capability to store execution results), the navigation controls may be operated to skip among stored execution results. For example, screen controls (e.g., navigation arrows) may be provided to enable the second user to skip from one identified event of interest to another. The screen controls may enable navigating in a sequential fashion (e.g., chronologically arranged, or in reverse chronological order) among the events of interest, or may enable direct selection of a particular event of interest (e.g., each event of interest being identified by an excerpt from the associated collected data).

When a particular event of interest is selected (e.g., navigated to) collected data that is associated with that event of interest is retrieved (block 230). For example, a corresponding record of a database may be retrieved, a corresponding data structure may be brought into scope, a corresponding data file may be opened, or the collected data may be otherwise retrieved.

Upon retrieval of the collected data for the selected event of interest, the software debugging tool reproduces a displayed screen environment that was displayed to the first user when the first user indicated that event of interest (block 240). For example, displayed execution results may correspond to execution results that were displayed when the first user indicated that event of interest. Any annotations and comments that were entered by the first user in connection with that event of interest may be displayed (or indicated for optional selection for display by the second user). A configuration or layout of a displayed screen or user interface may be similar or identical the configuration or layout that was displayed to the first user at the time of indication of that event of interest.

The second user may operate the software debugging tool, beginning from a selected event of interest, independently of any intentions of the first user. For example, the second user may explore other execution results, may continue execution in another manner (e.g., continue stepping through the execution of the debugged program), or may otherwise continue to operate the software debugging tool as desired.

In accordance with embodiments, the second user may indicate an additional event of interest, or may modify or edit data (or deleted, e.g., a previously indicated event of interest or an annotation associated with a previously indicated event of interest) that was collected in connection with an event of interest that was indicated by the first user. In this case, the second user acts as the first user, and debugging session handover method 100 (FIG. 2) may be executed.

The modified or additional event of interest data may be made available to another user (e.g., the original first user or another user). That other user may then act as the second user and event of interest examination method 200 may be executed.

In this manner, a second user may examine events that were noted by a first user during a debugging session, without the need for the second user to reproduce a possibly tedious process of executing all other events, preceding steps of execution, or immediate steps of execution.

1. A method comprising:
during operation of a software debugging tool with post-process capability on a software program, and upon indication by a first user of the software debugging tool of a step of the operation as an event of interest, collecting data related to that event of interest;
assigning a unique identifier to the collected data; and
enabling access to the collected data by a second user of the software debugging tool.

2. The method of claim 1, wherein collecting the data comprises enabling entering of an annotation.

3. The method of claim 1, wherein the collected data comprises a configuration of displayed execution data.

4. The method of claim 1, wherein enabling access comprises storing the collected data and the unique identifier in a database that is accessible by the second user.

5. The method of claim 5, wherein the database is accessible to the first user and to the second user via a network.

6. The method of claim 1, wherein enabling access comprises sending a notification to the second user.

7. The method of claim 1, further comprising enabling the second user to operate the software debugging tool to utilize the identifier of each of a plurality of the events of interest that were indicated by the first user to navigate to a selected event of interest of said plurality of the events of interest.

8. The method of claim 7, wherein navigating to the selected event of interest comprises reproducing a configuration of a display by the software debugging tool.

9. The method of claim 7, wherein navigating to the selected event of interest comprises enabling access to an annotation related to the selected event of interest.

10. A non-transitory computer readable storage medium having stored thereon instructions that when executed by a processor will cause the processor to perform the method of:
enabling indication of an event of interest during operation of a software debugging tool with post-process capability;
collecting data related to the indicated event of interest;
assigning a unique identifier to the collected data; and
enabling access to the collected data.

11. The non-transitory computer readable storage medium of claim 10, wherein the stored instructions include instructions to enable entering of an annotation related to the indicated event of interest.

12. The non-transitory computer readable storage medium of claim 10, wherein the stored instructions include instructions to generate a notification regarding the identified event of interest.

13. The non-transitory computer readable storage medium of claim 10, wherein the stored instructions include instructions to store the collected data with the unique identifier.

14. The non-transitory computer readable storage medium of claim 10, wherein the stored instructions include instructions to enable selection of an event of interest from a plurality of the indicated events of interest.

15. The non-transitory computer readable storage medium of claim 14, wherein the stored instructions include instructions to reproducing a configuration of a display by the software debugging tool at the time of indication of the selected event of interest.

16. The non-transitory computer readable storage medium of claim 14, wherein the stored instructions include instructions to enable access to an annotation related to the selected event of interest.

17. The non-transitory computer readable storage medium of claim 14, wherein the stored instructions include instructions to enable continued operation of the software debugging tool after said selection of an event of interest.

18. A system comprising:
a processing unit in communication with a computer readable medium, wherein the computer readable medium contains a set of instructions wherein the processing unit is designed to carry out the set of instructions to:
enable indication of one or more events of interest during operation of a software debugging tool with post-process capability;
collect data related to each of said one or more events of interest;
assign a unique identifier to the collected data related to each of said one or more events of interest;
enable access to the collected data; and
enable selection of an event of interest of said one or more events of interest.

19. The system of claim 18, comprising a plurality of intercommunicating workstations.

20. The system of claim 18, wherein the selection of the event of interest is enabled at a workstation of said plurality of intercommunicating workstations that is different than a workstation of said plurality of intercommunicating workstations that is operated to indicate said one or more events of interest.
